(19) United States
(12) Patent Application Publication
(10) Pub. No.: US 2023/0201779 A1
(43) Pub. Date: Jun. 29, 2023

(54) HEATABLE MIXER FOR COMPOSITE PRODUCTS

(71) Applicant: SOPREMA, STRASBOURG (FR)

(72) Inventors: Pierre-Etienne BINDSCHEDLER, STRASBOURG (FR); Patrick BALL, BARR (FR)

(21) Appl. No.: 17/920,358

(22) PCT Filed: Apr. 1, 2021
(86) PCT No.: PCT/EP2021/058730

§ 371 Date: Oct. 20, 2022

(30) Foreign Application Priority Data
Apr. 22, 2020 (FR) 2003999

(51) Int. Cl. B01F 27/702; B01F 27/091; B01F 27/723; B01F 35/92; B01F 35/95; B29B 17/04

(52) U.S. Cl. CPC B01F 27/702; B01F 27/091; B01F 27/723; B01F 35/92; B01F 35/95; B29B 17/04; B29B 2017/046; B29K 2095/00

(57) ABSTRACT

The invention relates to a heatable mixer (1) for composite products based on thermoplastic material(s), having an elongated structure defining a longitudinal processing path between an inlet and an outlet and comprising a heated trough (3) wherein two mutually interpenetrating parallel twin screws (4 and 4) are mounted, forming member(s) for dimensionally reducing, heating and moving the products to be treated which are inserted at the inlet, each screw (4, 4′) comprising a heated and driven support shaft (5) arranged in the travelling direction (DT). Mixer (1) characterised in that the thread (4″) of each screw (4, 4) is an interrupted or discontinuous thread and comprises, over at least a major portion of the length of the relevant screw (4, 4′), a plurality of first blades (6) in the form of flat and smooth plates which are separated from each other axially and radially and all arranged according to a constant.

The present invention relates to the field of recycling and deriving value from waste from factories and construction sites in the context of materials and sealing systems, in particular in relation to bituminous sealing membranes, and relates to a heating mixer, to an installation for treating and recycling composite products based on thermoplastic materials and to a control method for such an installation.

In the context of the general trend of searching for a possible way of deriving value from waste, there is an increasing demand, and one which has currently not been met in a satisfactory manner either in terms of technology or economy, concerning the waste from factories and especially from construction sites in the field of sealing, in particular in relation to the bituminous sealing membranes.

The main problem encountered, which has hitherto not been solved in a satisfactory manner, concerns the presence of contaminants from which value cannot be derived, notably hard solid particles, of the metallic type, mineral type or other types (originating from assembly or fixing elements, from covering layers, from surface-protection layers, or similar), which are often intricately linked with the material from which value is to be derived (essentially the bituminous binder).

In particular, the deconstruction waste from the renovation market to this day represents a significant potential source of sealing membranes to be treated, currently estimated at about 100,000 tonnes per year in France (estimation by the chambre syndicale de létanchéité française [French Trade Association of Sealing]), this source being replenished every year. The landfill cost for this waste has been increasing for many years, and this trend is likely to continue, especially since a proper industrial solution for treating deconstruction waste has not been proposed thus far.

There is therefore a high and constant demand to try to find an industrial solution for reducing the consumption of an increasingly scarce fossil resource and which will actually be efficient in the recycling of sealing membranes.

However, the makeup and therefore the treatment of this waste are complex, since during building roof repairs, it is possible, and common practice, to superpose several layers of membranes on top of one another, and to assemble them by adhesive bonding or welding, and to mechanically fix them to the support.

However, after a certain number of repairs (dependent on the legislation of the relevant country), it is technically necessary and administratively compulsory to remove the entirety of the covering system and to fit new sealing on the roof (framework; flat roof or other) in the unprocessed state.

The waste recovered at the end of this total removal operation, referred to as deconstruction waste, mainly comprises laminates of bituminous membranes which are joined to one another and have various types of finish, notably granules of slates, sand, sheets of complexed aluminum (PET-alu). This waste may also contain solid contaminants, notably insulation (PUR, XPS, mineral wool, wood fibers, etc.), metallic components (metallic fasteners of the mechanically fixed membranes, saw blades for cutting up the waste, etc.), and various other kinds of detritus associated with storage in a dumpster for recovering waste on a construction site (rocks, stones, cans, etc.).

Thus, in relation to the demand expressed above, the composite products that it would be desirable to be able to treat in the context of the field of application concerned by the invention essentially comprise:

predominantly bituminous membranes containing a reinforcement (for example: non-woven PNT polyester or glass mat, etc.), a bituminous binder (example: polymer and bitumen, additives, filler, etc.), a surface finish (example: granules of slates, sand, complexed aluminum sheets, etc.). These membranes are potentially agglomerated into successive layers fused to one another during fitting by heating, thus forming plates (dimensions of the recovered plates: ˜1 m×˜1 m×(1 to 20) cm). As an alternative, the products to be treated may comprise rolls of bituminous membranes from production (second choice) or from manufacturing scrap of such rolls. As an alternative, these membranes may be pre-ground.

solid contaminants of various natures: insulators (PUR, XPS, mineral wool, wood fibers, etc.), metallic components (metallic fasteners of the mechanically fixed membranes, saw blades for cutting up the waste, etc.), and various kinds of detritus (sand, gravel, rocks, stones, cans, etc.).

At the end of at least one first phase of the treatment, the exiting (output) product should comprise in particular smooth bitumen-based binders, also including polymers and particles or fragments of dispersed fibers, preferably of a size smaller than 100 μm.

Moreover, whereas the inputs are at ambient temperature (typically between 0° C. and 30° C.), the output of this first phase of treatment should, through adequate transformation of the inputs, be at least at the use temperature of bituminous and thermoplastic binders, namely between 150° C. and 200° C. typically.

Such a state of the output facilitates its subsequent treatment, in particular the removal of macroscopic solid contaminants that have not been reduced, or have not been reduced sufficiently, during this first treatment phase (such as rocks, stones, gravel, screws, bolts, rivets, nails, sheet-metal fragments, etc.), and also its subsequent transfer and its processing in an economically valuable and advantageously reusable form.

To this end, and taking account of the type of inputs to be transformed/given economic value and their state at the inlet, the technical device carrying out said (at least) first treatment phase should, gradually and simultaneously, heat the inputs until a softening/melting temperature of the bituminous binder is reached (at least in the vicinity of the outlet), and subject the membranes (pre-cut or not) to shear in order to break down their reinforcements and bring about their disintegration. This device should furthermore allow the above-mentioned hard macroscopic contaminants to pass through without risk of blockage, and preferably exhibit a limited level of wear.

However, the apparatuses and installations known at present for recycling the type of products mentioned above do not make it possible to meet the demand above, nor to achieve the desired result, in any event not in a reliable or sustainable manner.

Thus, the separators of ferromagnetic metallic contaminants (with magnets) or non-ferromagnetic metallic contaminants (with eddy currents) target only one type of contaminants, do not transform the output products or do not transform them sufficiently, and do not permit the removal of embedded or interwoven elements or elements too intimately connected to the materials from which value is to be derived.

Likewise, the systems based on separation due to differences in densities between components, of the centrifugal system type, densimetric table type, settling device type or similar type, are either ineffective or not economically viable.

Certain known devices perform some, but not all, of the above-mentioned functions expected for the first treatment phase in a satisfactory manner.

Thus, the treatment devices of the heated Z-arm mixer type produce good shearing, but poor heating (batch method), and the paddle mixers exhibit satisfactory heating of the products and are resistant to contaminants, but produce substandard shearing.

Furthermore, the known systems (cf. notably WO 2008/103035, US 2005/263625, EP 1 123 182 and WO 2009/090546) in the form of conventional extruders or helical screw conveyors are, for their part, prone to blockages when a hard microscopic particle (of the screw or bolt type) is present and undergo significant and rapid wear in the presence of hard microscopic particles (such as sand).

Finally, double-Archimedean screw conveyor-mixers are also known, in which the screws and the trough are heated: they produce good heating and good shearing, but are also prone to blockages and to the significant wear mentioned above during the treatment of composite products/waste mentioned above.

The main aim of the invention is to improve the known double-screw mixers mentioned above in order to overcome their limitations.

To this end, a subject of the invention is a heating mixer for composite products based on thermoplastic material(s), notably waste from factories or construction sites predominantly containing bituminous membranes, said mixer having an elongate form defining a longitudinal treatment path between an inlet and an outlet, and comprising a heated trough in which at least one screw is mounted, preferably two parallel twinned and mutually interpenetrating screws, forming (a) dimensional reduction, heating and movement member(s) for the products to be treated introduced at the inlet, said or each screw comprising a heated and driven support shaft disposed along the direction of the path,

mixer characterized in that the thread of the or each screw is an interrupted or discontinuous thread and comprises, over at least a predominant part of the length of the screw considered, a plurality of first blades in the form of planar and smooth plates which are separated from one another axially and radially and which are all arranged at a constant thread pitch and with a determined inclination with respect to a plane perpendicular to the axis of the screw considered.

The invention will be better understood by means of the following description which relates to a preferred embodiment, given by way of non-limiting example and explained with reference to the schematic drawings attached, in which:

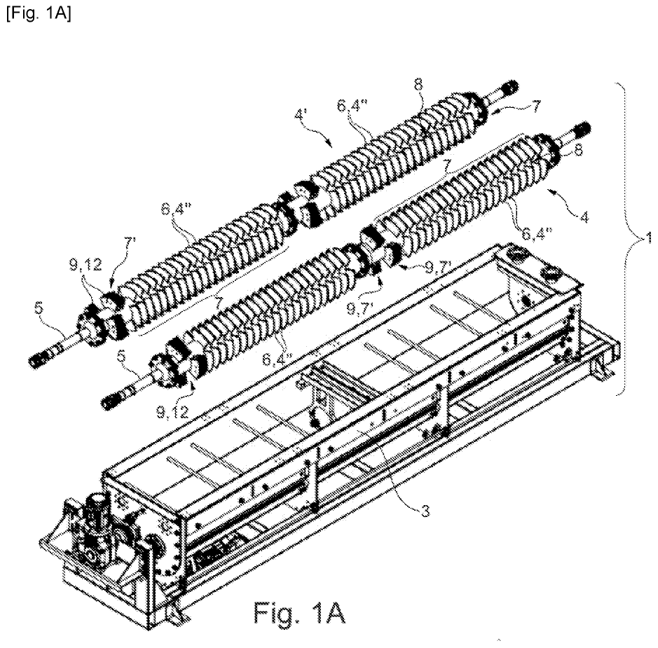

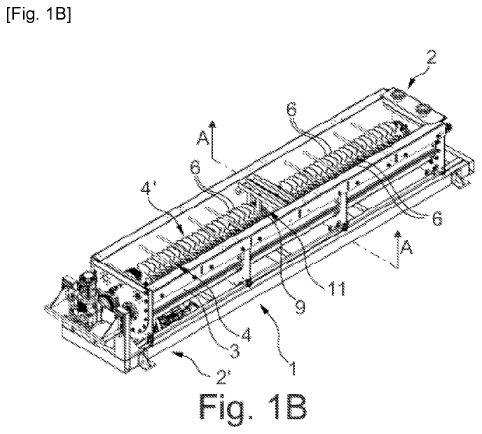

FIG. 1A is an exploded view of a heating mixer according to the invention;

FIG. 1B is a perspective view from above of a heating mixer according to FIG. 1A, the closure cover of the trough being removed;

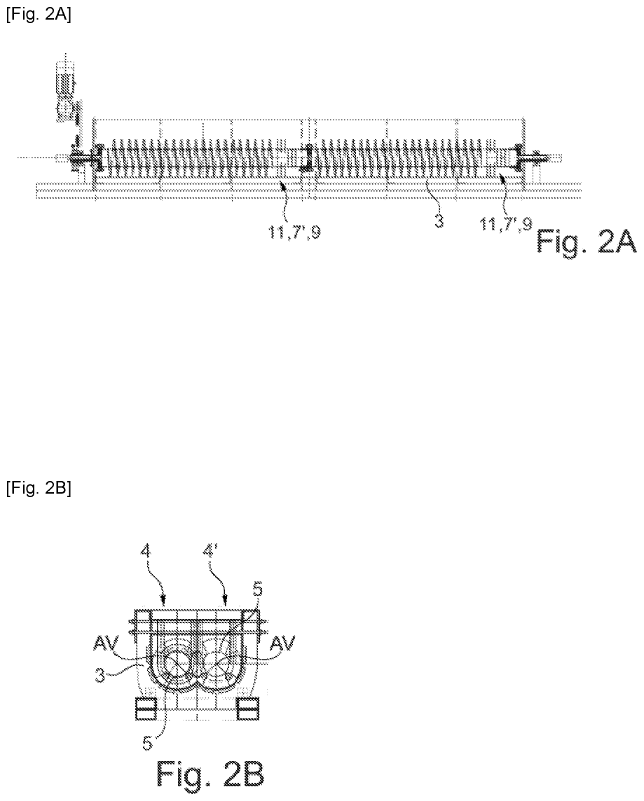

FIG. 2A is a view in section along a vertical plane containing the longitudinal axis of the mixer in FIG. 1B;

FIG. 2B is a partially transparent view in elevation in the direction of the longitudinal axis of the mixer shown in FIG. 1B;

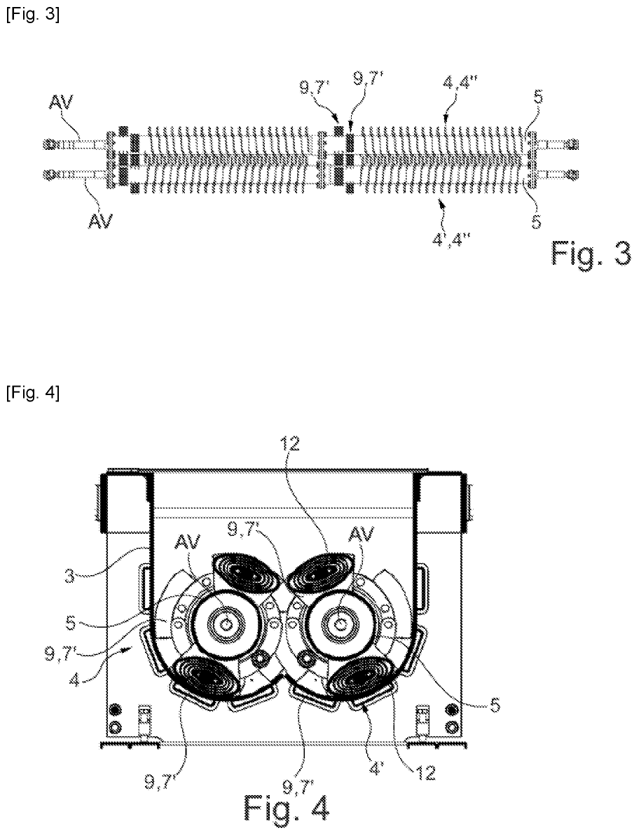

FIG. 3 is a view from above of the two screws forming part of the mixer in FIGS. 1 and 2;

FIG. 4 is a view in section, along A-A, of the mixer in FIG. 1B;

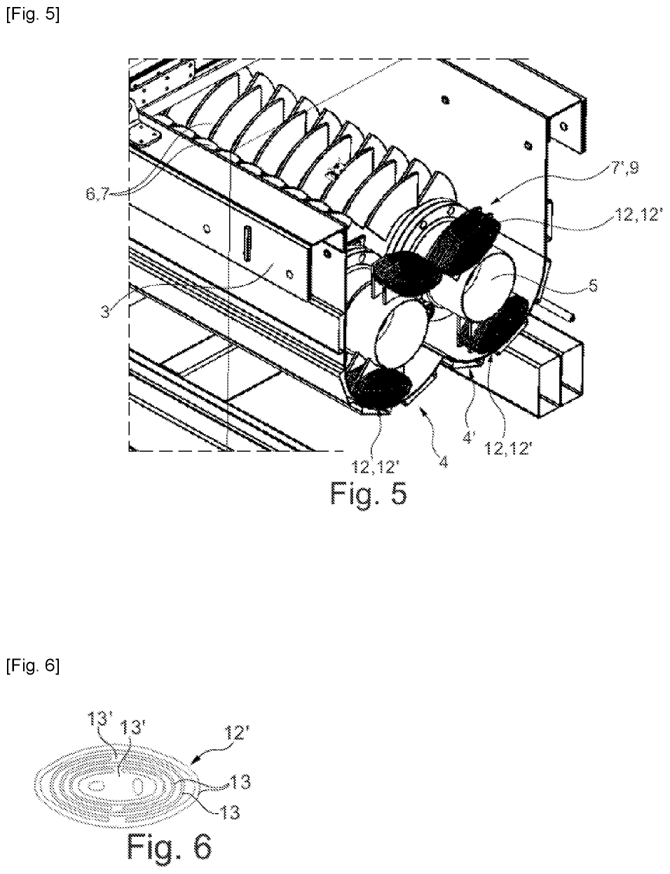

FIG. 5 is a partial and perspective view of the mixer in FIG. 4;

FIG. 6 is a detail view of a scraping structure forming part of the mixer shown in FIGS. 4 and 5; and

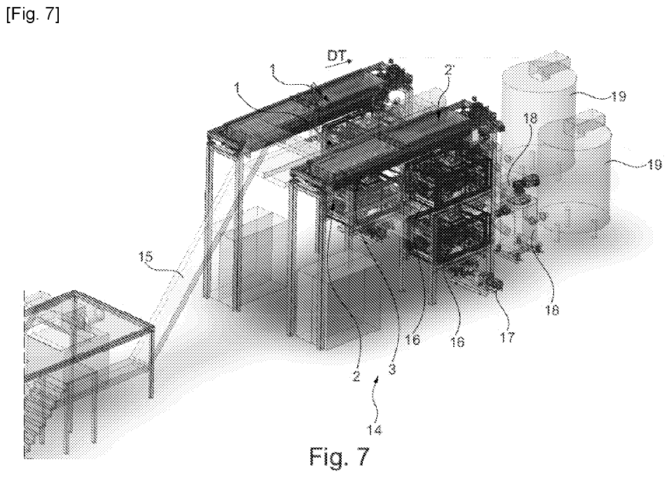

FIG. 7 is a perspective view of a treatment and recycling installation comprising two mixers according to FIGS. 1 to 5, mounted in parallel and forming the first treatment stations of this installation.

FIGS. 1 to 7 illustrate, at least in part, a heating mixer 1 for composite products based on thermoplastic material(s), notably waste from factories or construction sites predominantly containing bituminous membranes.

This mixer 1 has an elongate form defining a longitudinal treatment path between an inlet 2 and an outlet 2′, and comprises a heated trough 3 in which at least one screw 4, 4′ is mounted, preferably two parallel twinned and mutually interpenetrating screws 4 and 4′, forming (a) dimensional reduction, heating and movement member(s) for the products to be treated introduced at the inlet 2, said or each screw 4, 4′ comprising a heated and driven support shaft 5 disposed along the direction DT of the path.

In accordance with the invention, the thread 4″ of the or each screw 4, 4′ is an interrupted or discontinuous thread and comprises, over at least a predominant part of the length of the screw 4, 4′ considered, a plurality of first blades 6 in the form of planar and smooth plates which are separated from one another axially and radially and which are all arranged at a constant thread pitch and with a determined inclination with respect to a plane perpendicular to the axis AV of the screw 4, 4′ considered.

The helical thread 4″ of each of the two screws 4, 4′, which rotate in mutually opposite directions of rotation so as to generate a movement for transporting material from the inlet 2 to the outlet 2′ of the trough 3 (in the direction DT), is therefore made up of a plurality of blades 6 in the form of planar ring sectors which are distinct and separate and secured (by welding for example) to the shaft 5 of the screw 4, 4′ in question along a helical line. Moreover, these blades 6 are arranged with a mutual spacing and an individual angular extension such that longitudinal rows 7 of blades 6 are formed.

Preferably, each first blade 6 has an angular extension around the shaft considered of less than 180°, advantageously less than 120°, preferably about 90°. Moreover, said first blades 6 are configured and arranged on the support shaft 5 in question so as to form a limited number of rows 7 of blades 6 in the direction of the axis AV of the screw 4, 4′, said rows being distributed around the circumference of the support shaft 5 and defining between them clear zones 8 extending along the screw 4, 4′ between neighboring rows 7.

Thus, each of the screws 4, 4′ is substantially in the form of an Archimedean screw with continuous helical thread, but cut in the direction of the axis AV of the shaft 5 so as to form rectilinear apertures parallel to said axis AV.

It is the spacings between the blades 6, and more particularly the passages in the form of resultant apertures, which permit the blockage-free transport of macroscopic contaminants from the inlet 2 to the outlet 2′.

Advantageously, the trough 3 comprises a jacket and the shaft 5 is a hollow tube, both being passed through by a hot fluid (oil). Moreover, the metallic blades 6 are relatively thick (for example 8 to 15 mm) so as to guarantee a certain thermal inertia in order to heat the bitumen in the mass, while still entrapping and “lifting off” the inputs in the form of membranes. (effect of “introducing a hot knife into cold butter”). Furthermore, by being planar and smooth, the blades 6 do not offer anything for the bituminous binder or other constituents to catch on.

In accordance with a preferred variant embodiment, illustrated in FIGS. 1, 2, 4 and 5, it is provided that the or each screw 4, 4′ comprises, over at least a part of its length, a plurality of second blades 9 in the form of planar plates which are separated from one another and which are all arranged along planes perpendicular to the axis of the screw 4, 4′ considered, that each second blade 9 has an angular extension of less than 180°, advantageously less than 120°, preferably about 90°, and that said second blades 9 are configured and arranged on the support shaft 5 in question so as to form a limited number of rows 7′ of blades in the direction of the axis AV of the screw 4, 4′ and around the shaft 5, clear zones extending between the neighboring rows 7′ (angularly or circumferentially) along the screw 4, 4′.

Whereas the first place 6 are mounted on the respective shaft 5 with an inclination with respect to a plane perpendicular to the axis AV of said shaft, the second blades 9 are, for their part, mounted perpendicularly with respect to this axis AV.

Advantageously, each row 7′ of second blades 9 extends only over a fraction of the length of the part of the screw 4, 4′ comprising them and over a fraction of the circumference of the shaft 5 of said screw and forms at least one local group of second blades 9, each group being offset angularly and/or axially with respect to each of the other groups, and at least one, preferably each, group of second blades 9 of one screw 4, 4′ coming into interpenetrating engagement, in an interstitial manner, with a corresponding group of second blades 9 of the other screw 4′, 4.

In addition or as an alternative, the trough 3 may comprise, over at least a part of its internal face that is situated facing the longitudinal part or parts of the screw 4, 4′ comprising second blades 9, fixed counter-blades which are situated in planes that are parallel and interstitial with respect to the planes of the second blades 9 and which come into interpenetrating engagement with the second blades 9 during the rotation of the screw 4, 4′ considered, each cooperating arrangement of at least two groups of movable second blades 9 respectively belonging to one of the two screws 4, 4′, and possibly of fixed counter-blades, forming a preferred shear module 11.

Thus, the second blades 9 of the screws 4, 4′ not only engage and interpenetrate between the two screws 4, 4′, but also with fixed counter-blades installed in the trough 3, for example on a support structure mounted in the trough 3 (not shown) in an interchangeable manner.

The zones of the mixer 1 comprising groups of multiple movable second blades 9, and possibly of fixed counter-blades, form, due to the density of elements forming interpenetrating blades with small gaps, intense shear modules. The mixer 1 may comprise one or more such modules, if applicable distributed along the trough 3. Preferably, a (last) shear module is arranged close to the outlet of the mixer 1.

The distribution of the second blades 9 in circumferentially and/or axially spaced-apart rows 7′ makes it possible for solid macroscopic contaminants to pass through the zones of these modules without blocking the screws 4, 4′.

As shown by way of illustrative example in FIGS. 2A and 3, the or each screw is advantageously formed of differentiated longitudinal segments alternately comprising rows of inclined first blades 6 and rows of perpendicular second blades 9.

In order to limit the wear of the first and/or second blades 6, 9 (by the creation of a sufficient gap between their outer edges and the wall of the trough 3), while still promoting thermal transfer between the screws 4, 4′ and/or the trough 3 and the products to be treated being conveyed, and also shearing (in spite of the presence of a significant gap—for example 0.5 mm to 3 to 5 cm—between the blades 6, 9 and trough 3), provision may be made for at least certain first and/or second blades 6, 9 to be provided, at their outer free edge 9′, with at least one attached scraping structure 12 which protrudes radially with respect to said edge 9′ and which is elastically deformable at least in a radial direction (see FIGS. 4 to 6).

In accordance with a preferred embodiment, which can be seen in the above-mentioned figures, the or each deformable attached structure 12 consists of a small plate 12′, or of a stack of at least two small plates 12′, with a substantially elliptical contour and having cutouts defining a plurality of concentric elliptical rings 13, connected by bridges of material 13′ between adjacent rings 13, said structure 12 being mounted on the corresponding blade 6, 9 with such an orientation that the direction of the semi-minor axis of the elliptical contour passes through the longitudinal axis AV of the support shaft 5.

Although not shown, the heating mixer 1 according to the invention may comprise only one screw.

Still in a preferred manner, said mixer 1 comprises two twinned parallel screws 4 and 4′, the respective blades 6, 9 of which intertwine intimately over at least a part of their height, preferably a predominant part, either in at least one zone of mutual meshing of opposite threads of first blades 6 inclined with respect to the axis of the support shaft 5, or in at least one zone of mutual interpenetration of second blades 9 perpendicular to the axis of the support shaft 5, advantageously in both types of zones.

Another subject of the invention, as shown for example in FIG. 7, is an installation 14 for treating and recycling thermoplastic-based composite products, for example waste predominantly incorporating bituminous products, notably bituminous membranes.

This installation 14 is characterized in that it comprises, as treatment station(s), at least one mixer 1 as described above, preferably as first treatment station.

As shown in FIG. 7, the installation 14 may comprise two heating mixers 1 as described above, mounted in parallel, fed with inputs by way of a conveyor belt 15 (transporting, for example, pre-cut waste) and each forming the first station of a treatment and recycling line, respectively associated downstream.

The mixers 1 are installed high up and their liquid or semi-liquid outputs fall through two superposed grinding stations 16 each formed of an opposite roller mill (the gaps of which are aligned). Between the two stations 16, there may be arranged a device for separating off solid macroscopic contaminants, in the form of a discharge device (not specifically visible) with movable (by pivoting) extractor unit. Then, the purified output of macroscopic contaminants may be transferred (for example by a macerator pump 17) into a refiner 18 with a drum mounted in an eccentrically movable manner in a cylindrical enclosure, in order to then be stored in a tank 19, in the form of a reusable economically valuable product.

The invention also relates to a method for controlling a mixer 1 as described above, characterized in that it consists in driving the screw or screws 4, 4′ with a control protocol comprising at least two driving phases which cause materials in the mixer 1 to move in the direction DT of the treatment path, said driving phases being separated by at least one opposite driving phase, that is to say a driving phase which causes the treated materials to move in the direction opposite to the treatment path, the occurrence, the duration and the number of opposite driving phases being either predetermined or dependent on values provided by sensors for measuring operating parameters, such as the driving torque, the composition and/or the quality of the products treated, the quantity of materials present in the mixer 1.

Of course, the invention is not restricted to the embodiment described and shown with respect to the attached figures. Modifications remain possible, in particular as regards the makeup of various elements or by substitution of technical equivalents, without otherwise departing from the scope of protection of the invention.

1-11. (canceled)

12. A heating mixer for composite products based on thermoplastic material(s), notably waste from factories or construction sites predominantly containing bituminous membranes, said heating mixer comprising:
an elongate form defining a longitudinal treatment path between an inlet and an outlet, and
a heated trough in which at least one screw is mounted forming a dimensional reduction, heating and movement member(s) for the products to be treated introduced at the inlet, said or each screw comprising a heated and driven support shaft disposed along the direction of the path, wherein the thread of the at least one screw is an interrupted or discontinuous thread and comprises, over at least a predominant part of the length of the screw, a plurality of first blades in the form of planar and smooth plates which are separated from one another axially and radially and which are all arranged at a constant thread pitch and with a determined inclination with respect to a plane perpendicular to the axis of the considered screw,
wherein the at least one screw comprises, over at least a part of its length, a plurality of second blades in the form of planar plates which are separated from one another and which are all arranged along planes perpendicular to the axis of the screw considered, in that each second blade has an angular extension of less than 180°, and in that said second blades are configured and arranged on the support shaft in question so as to form a limited number of rows of blades in the direction of the axis of the screw and around the shaft, clear zones extending between the neighbouring rows along the screw.

13. A heating mixer for composite products based on thermoplastic material(s), notably waste from factories or construction sites predominantly containing bituminous membranes, said heating mixer comprising:
an elongate form defining a longitudinal treatment path between an inlet and an outlet, and comprising a heated trough in which at least one screw is mounted, forming a dimensional reduction, heating and movement member(s) for the products to be treated introduced at the inlet, said or each screw comprising a heated and driven support shaft disposed along the direction of the path, wherein thread of the screw is an interrupted or discontinuous thread and comprises, over at least a predominant part of the length of the at least one screw, a plurality of first blades in the form of planar and smooth plates which are separated from one another axially and radially and which are all arranged at a constant thread pitch and with a determined inclination with respect to a plane perpendicular to the axis of the screw considered,
wherein at least certain first blades are provided, at their outer free edge, with at least one attached scraping structure which protrudes radially with respect to said outer free edge, and which is elastically deformable at least in a radial direction.

14. The heating mixer as claimed in claim 12, wherein each first blade has an angular extension around the shaft considered of less than 180°, and in that said first blades are configured and arranged on the support shaft so as to form a limited number of rows of blades in the direction of the axis of the screw, said rows being distributed around the circumference of the support shaft and defining between them clear zones extending along the screw between neighbouring rows.

15. The heating mixer as claimed in claim 12, wherein each row of second blades extends only over a fraction of the length of the part of the screw and over a fraction of the circumference of the shaft of said screw and forms at least one local group of second blades, each group being offset angularly and/or axially with respect to each of the other groups, and at least one group of second blades of one screw coming into interpenetrating engagement, in an interstitial manner, with a corresponding group of second blades of the other screw.

16. The heating mixer as claimed in claim 12, wherein the trough comprises, over at least a part of its internal face that is situated facing the longitudinal part or parts of the at least one screw comprising second blades, fixed counter-blades which are situated in planes that are parallel and interstitial with respect to the planes of the second blades and which come into interpenetrating engagement with the second blades during the rotation of the screw, each cooperating arrangement of at least two groups of second blades respectively belonging to the screw, and possibly of counter-blades, forming a shear module.

17. The heating mixer as claimed in claim 12, wherein the at least one screw is formed of differentiated longitudinal segments alternately comprising rows of inclined first blades and rows of perpendicular second blades.

18. The heating mixer as claimed in claim 13, wherein the or each deformable scrapping structure is a small plate, or of a stack of at least two small plates, with a substantially elliptical contour and having cutouts defining a plurality of concentric elliptical rings, connected by bridges of material between adjacent rings, said structure being mounted on the corresponding blade with such an orientation that the direction of the semi-minor axis of the elliptical contour passes through the longitudinal axis of the corresponding support shaft.

19. The heating mixer as claimed in claim 12, wherein said mixer comprises two parallel twinned and mutually interpenetrating screws, the respective blades of which intertwine intimately over at least a part of their height, either in at least one zone of mutual meshing of opposite threads of first blades inclined with respect to the axis of the support shaft, or in at least one zone of mutual interpenetration of second blades perpendicular to the axis of the support shaft.

20. An installation for treating and recycling thermoplastic-based composite products, for example waste predominately incorporating bituminous products, notably bituminous membranes, said installation comprises, as treatment station(s), at least one mixer as claimed in claim 12.

21. A method for controlling a mixer as claimed in claim 12, wherein said method comprises the steps of:
driving the at least one screw or screws with a control protocol comprising at least two driving phases which cause materials in the mixer to move in the direction of the treatment path, said driving phases being separated by at least one opposite driving phase, that is to say a driving phase which causes the treated materials to move in the direction opposite to the treatment path, the occurrence, the duration and the number of opposite driving phases being either predetermined or dependent on values provided by sensors for measuring operating parameters.

22. The heating mixer as claimed in claim 12, wherein each second blade has an angular extension of less than 120°.

23. The heating mixer as claimed in claim 12, wherein each second blade has an angular extension of about 90°.

24. The heating mixer as claimed in claim 13, further comprising, over at least a part of its length, a plurality of second blades in the form of planar plates which are separated from one another and which are all arranged along planes perpendicular to the axis of the screw considered, in that each second blade has an angular extension of less than 180°, and in that said second blades are configured and arranged on the support shaft so as to form a limited number of rows of blades in the direction of the axis of the at least one screw and around the shaft, clear zones extending between the neighbouring rows along the screw.

25. The heating mixer as claimed in claim 14, wherein each first blade has an angular extension of less than 120°.

26. The heating mixer as claimed in claim 14 wherein each first blade has an angular extension of about 90°.

27. The method as claimed in claim 21, wherein said measuring operating parameters are selected from the group consisting of a driving torque, a composition and/or a quality of the products treated, and a quantity of materials present in the mixer.

28. The heating mixer as claimed in claim 13, wherein the at least one screw is formed of differentiated longitudinal segments alternately comprising rows of inclined first blades and rows of perpendicular second blades.

29. The heating mixer as claimed in claim 13, wherein said mixer comprises two parallel twinned and mutually interpenetrating screws, the respective blades of which intertwine intimately over at least a part of their height, either in at least one zone of mutual meshing of opposite threads of first blades inclined with respect to the axis of the support shaft, or in at least one zone of mutual interpenetration of second blades perpendicular to the axis of the support shaft.

30. An installation for treating and recycling thermoplastic-based composite products, for example waste predominately incorporating bituminous products, notably bituminous membranes, said installation comprises, as treatment station(s), at least one mixer as claimed in claim 13.

31. A method for controlling a mixer as claimed in claim 13, wherein said method comprises the steps of:
driving the at least one screw with a control protocol comprising at least two driving phases which cause materials in the mixer to move in the direction of the treatment path, said driving phases being separated by at least one opposite driving phase, that is to say a driving phase which causes the treated materials to move in the direction opposite to the treatment path, the occurrence, the duration and the number of opposite driving phases being either predetermined or dependent on values provided by sensors for measuring operating parameters.
